(19) United States
(12) Patent Application Publication
(10) Pub. No.: US 2015/0113237 A1
(43) Pub. Date: Apr. 23, 2015

(54) DATA STORING SYSTEM AND OPERATING METHOD THEREOF

(71) Applicant: SK hynix Inc., Gyeonggi-do (KR)

(72) Inventor: Tae Hoon KIM, Gyeonggi-do (KR)

(73) Assignee: SK hynix Inc., Gyeonggi-do (KR)

(21) Appl. No.: 14/221,010

(22) Filed: Mar. 20, 2014

(30) Foreign Application Priority Data
Oct. 21, 2013 (KR) 10-2013-0125398

(51) Int. Cl. G06F 3/06

(52) U.S. Cl. CPC G06F 3/065; G06F 3/0604; G06F 3/0679
USPC 711/162

(57) ABSTRACT

A method of operating a data storing system includes performing a first copy operation of copying data stored in memory cells of first to n^{th} word lines (n>1, and n is an integer) of a first memory block to first to n^{th} pages of a word line of a second memory block; if a power is turned off, searching for a first erase page, which is recognized to be in an erase state, among the pages of the second memory block when the power comes back on; performing a first map-update on copied pages of the second memory block except for a set number of pages copied right before the first erase page; and performing a second copy operation from the first erase page.

### CROSS-REFERENCE TO RELATED APPLICATION

The present application claims priority of Korean patent application number 10-2013-0125398, filed on Oct. 21, 2013, the entire disclosure of which is incorporated herein by reference in its entirety.

### BACKGROUND

1. Field of Invention

Various embodiments of the present invention relate to an electronic device, and more particularly, to a data storing system and an operating method of the data storing system.

2. Description of Related Art

A semiconductor memory device among semiconductor devices included in a data storing device is generally classified into a volatile memory device and a nonvolatile memory device.

The volatile memory device has a high write and read rate, but loses stored data when a power supply is cut off. The nonvolatile memory device has a relatively love write and read rate, but maintains stored data even though a power supply is cut off. Accordingly, the nonvolatile memory device is used in order to store data which needs to be maintained regardless of the power supply. Examples of the nonvolatile memory device includes a Read Only Memory (ROM), a Mask ROM (MROM), a Programmable ROM (PROM), an Erasable Programmable ROM (EPROM), an Electrically Erasable Programmable ROM (EEPROM), a flash memory, a Phase-change RAM (PRAM), a Magnetic RAM (MRAM), a Resistive RAM (RRAM), a Ferroelectric RAM (FRAM), and the like. The flash memory is generally classified into a NOR type and a NAND type.

The flash memory has an advantage of the RAM in which data is freely programmed and erased, and an advantage of the ROM maintaining stored data even though a power supply is cut off. The flash memory is widely used as a storage medium of a portable electronic device, such as a digital camera, a Personal Digital Assistant (PDA), and an MP3 player,

The data storing system having high data reliability is in demand.

### SUMMARY

The exemplary embodiment of the present invention is directed to a data storing system having high data reliability, and an operating method of the data storing system.

An exemplary exemplary embodiment of the present invention provides a method of operating a data storing system, including performing a first copy operation of copying data stored in memory cells of first to n^{th} word lines of a first memory block to first to n^{th} pages of a word line of a second memory block, wherein the n is an integer greater than 1, if a power is turned off, searching for a first erase page, which is recognized to be in an erase state, among the pages of the second memory block when the power comes back on, performing a first map-update on copied pages of the second memory block except for a set number of pages copied right before the first erase page, and performing a second copy operation from the first erase page.

Another exemplary exemplary embodiment of the present invention provides a data storing system, including a semiconductor device suitable for performing a first copy operation of copying data stored in memory cells of first to n^{th} word lines of a first memory block to first to n^{th} pages of a word line of a second memory block in response to a command and an address, wherein the n is an integer greater than 1, and a controller suitable for generating the command and the address and performing a map-update on copied pages of the second memory block, wherein when a power is turned on after a sudden power off, the controller detects a first erase page, which is recognized to be in an erase state, among the pages of the second memory block and performs the map-update on the coped pages except for set number of pages copied right before the first erase page.

According to the exemplary embodiment of the present invention, the data storing system and the operating method of the data storing system may prevent performance of the program operation on an unstable page by Sudden Power Off (SPO), thereby improving reliability of data.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The above and other features and advantages of the present invention will become more apparent to those of ordinary skill in the art by describing in detail embodiments thereof with reference to the attached drawings in which:

FIG. 1 is a block diagram illustrating a data storing system according to an exemplary embodiment of the present invention;

FIG. 2 is a block diagram for describing a controller illustrated in FIG. 1;

FIG. 3 is a block diagram for describing a semiconductor device illustrated in FIG. 1;

FIG. 4 is a circuit diagram for describing a memory block illustrated in FIG. 3;

FIG. 5 is a circuit diagram for describing a page buffer illustrated in FIG. 3;

FIG. 6 is a block diagram for describing data transmission between the memory block illustrated in FIG. 4 and the page buffer illustrated in FIG. 5;

FIG. 7 is a diagram for describing a program sequence used in the semiconductor device illustrated n FIG. 3;

FIG. 8 is a flowchart illustrating an operating method of the data storing system according to the exemplary embodiment of the present invention.

FIGS. 9 to 14 are flowcharts illustrating detailed steps of the operating method of the data storing system illustrated in FIG. 8;

FIG. 15 is a diagram for describing the operating method of the data storing system according to the exemplary embodiment of the present invention in a 3 bit multi-level cell;

FIG. 16 is a block diagram for describing a detailed configuration of the controller illustrated in FIG. 1;

FIG. 17 is a block diagram schematically illustrating a fusion memory device or a fusion memory system performing a program operation according to the exemplary embodiment of the present invention; and

FIG. 18 is a block diagram schematically illustrating a computing system including the semiconductor device according to the exemplary embodiment of the present invention.

### DETAILED DESCRIPTION

Hereinafter, an embodiment of the present invention will be described with reference to the accompanying drawings in detail. However, the present invention is not limited to an embodiment disclosed below and may be implemented in various forms and the scope of the present invention is not limited to the following embodiments. Rather, the embodiment is provided to more sincerely and fully disclose the present invention and to completely transfer the spirit of the present invention to those skilled in the art to which the present invention pertains, and the scope of the present invention should be understood by the claims of the present invention. Throughout the disclosure, reference numerals correspond directly to the like numbered parts in the various figures and embodiments of the present invention. It is also noted that in this specification, “connected/coupled” refers to one component not only directly coupling another component but also indirectly coupling another component through an intermediate component. In addition, a singular form may include a plural form as long as it is not specifically mentioned in a sentence.

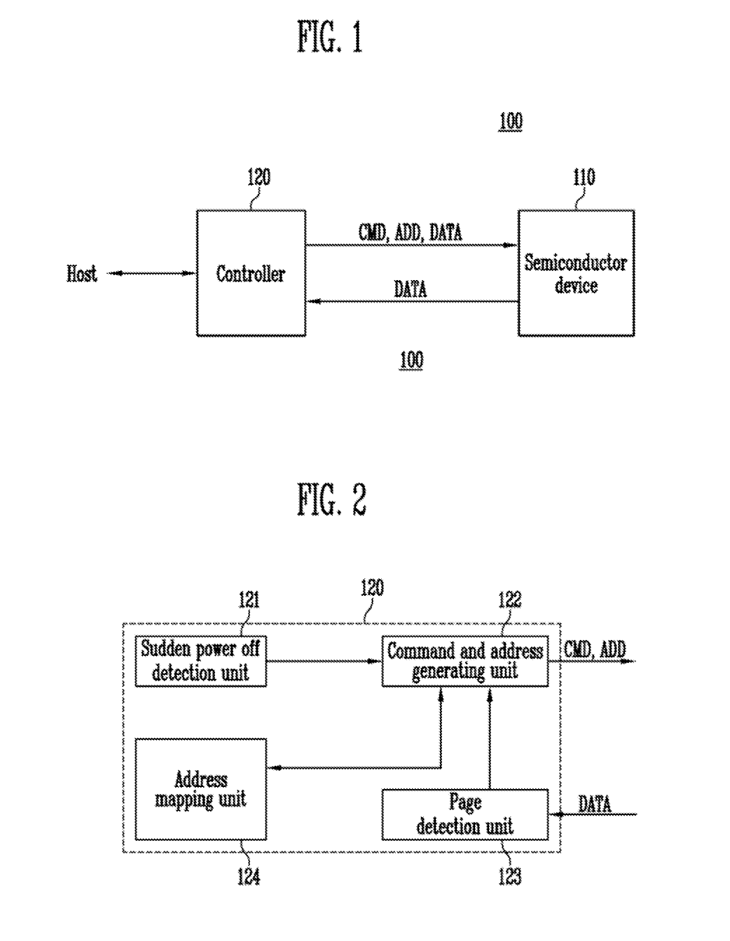

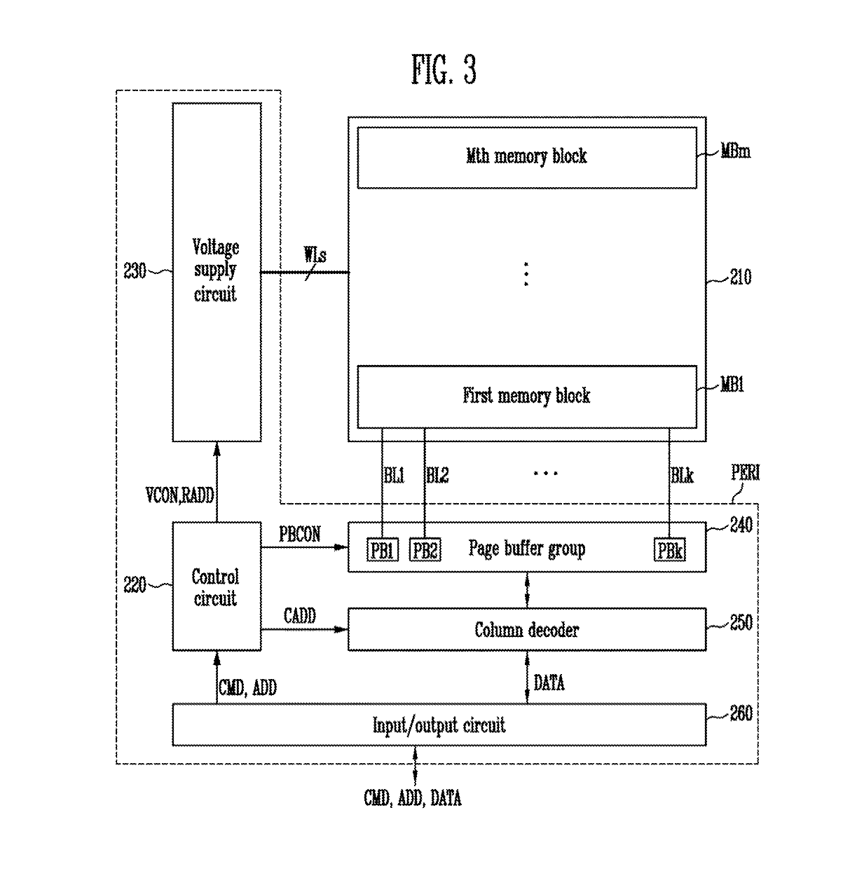

FIG. 1 is a block diagram for describing a data storing system according to an exemplary embodiment of the present invention. FIG. 2 is a block diagram for describing a controller illustrated in FIGS. 1.

Referring to FIG. 1, a data storing system 100 may include a semiconductor device 110, and a controller 120 for controlling an operation of the semiconductor device 110 in response to a request of a host.

The semiconductor device 110 performs a program operation or a read operation on memory cells of pages included in a memory block in response to a command CMD and an address ADD inputted from the controller 120. The semiconductor device 110 programs data DATA inputted from the controller 120 on memory cells of a program target page, and outputs data DATA read from the memory cells to the controller 120.

The semiconductor device 110 performs a copy operation of copying data stored in memory cells of first to n^{th} word lines (n>1 and n is an integer) of a first memory block to memory cells of first to n^{th}pages of a word line of a second memory block.

The semiconductor device 110 stores data of 1 bit in the memory cell of the first memory block, and stores data of n bits in the memory cell of the second memory block.

When the semiconductor device 110 performs the copy operation, the semiconductor device 110 reads the data stored in the memory cells of the first to n^{th} word lines of the first memory block, and then programs the read data in first to n^{th} pages of the word line of the second memory block.

Referring to FIG. 2, the controller 120 includes a sudden power off detection unit 121, a command and address generating unit 122, a page detection unit 123, and an address mapping unit 124.

The sudden power off detection unit 121 detects generation of sudden power off during performance of the copy operation in the data storing system 100, and generates a detection signal when the data storing system 100 is powered on.

The command and address generating unit 122 generates a command CMD and an address ADD in response to the detection signal inputted from the sudden power off detection unit 121 so that a read operation (read scan operation) is performed on the pages of the second memory block, in which the program operation is stopped by the sudden power off.

The page detection unit 123 detects a first page (first erase page), which is recognized to be in an erase state among the pages of the second memory block, based on the data read from the semiconductor device 110 by the read operation. The page detection unit 123 detects the first page, in which any data is not stored, among the pages of the second memory block as the first erase page.

The address mapping unit 124 performs updating of a map on pages except for the specific number of pages copied before the first erase page among the pages, on which the copy operation is performed, based on the detection result of the page detection unit 123. In other words, updating of a map on the specific number of pages copied before the first erase page is skipped. The address mapping unit 124 includes a mapping table for converting a logical address inputted from the host to a physical address, and updates addresses of first to n^{th} world lines of the first memory block on a mapping table to addresses of the first to n^{th} pages of the second memory block. That is, the address mapping unit 124 updates the physical address corresponding to the logical address.

The command and address generating unit 122 generates a command CMD and an address ADD for the semiconductor device 110 to perform the copy operation from the first erase page again.

When the performance of the copy operation from the first erase page is completed, the address mapping unit 124 performs the updating of the map on the pages on which the copy operation is performed.

Subsequently, the command and address generating unit 122 generates a command CMD and an address ADD to perform the copy operation of copying data stored in the memory cells of the word lines of the first memory block corresponding to the specific number of pages to the specific number of pages of the third memory block.

As an exemplary embodiment, the command and address generating unit 122 may generate the command CMD and the address ADD so that the operation of copying the data to the third memory block is performed during performance of the copy operation of another memory block.

As an exemplary embodiment, the command and address generating unit 122 may generate a command CMD and an address ADD so that the operation of copying the data to the third memory block is performed during a garbage collection operation.

As an exemplary embodiment, the data storing system 100 may save which page of the memory block is programmed, as log data. That is, the data storing system 100 may leave a program start page and a program end page as log data Accordingly, it may be recognized through the log data which page performs the operation after the sudden power off. Accordingly, it may be recognized through checking the log data whether a page performs the same operation as that of the data storing system 100 according to the exemplary embodiment of the present invention.

The data storing system 100 prevents the program operation from being performed on an unstable page due to the sudden power off, thereby improving reliability. The unstable page may include a program page, which has been programmed but is unstable due to the sudden power off, and an erase page, which is recognized in an erase state but is slightly programmed due to the sudden power off to be vulnerable to disturbance.

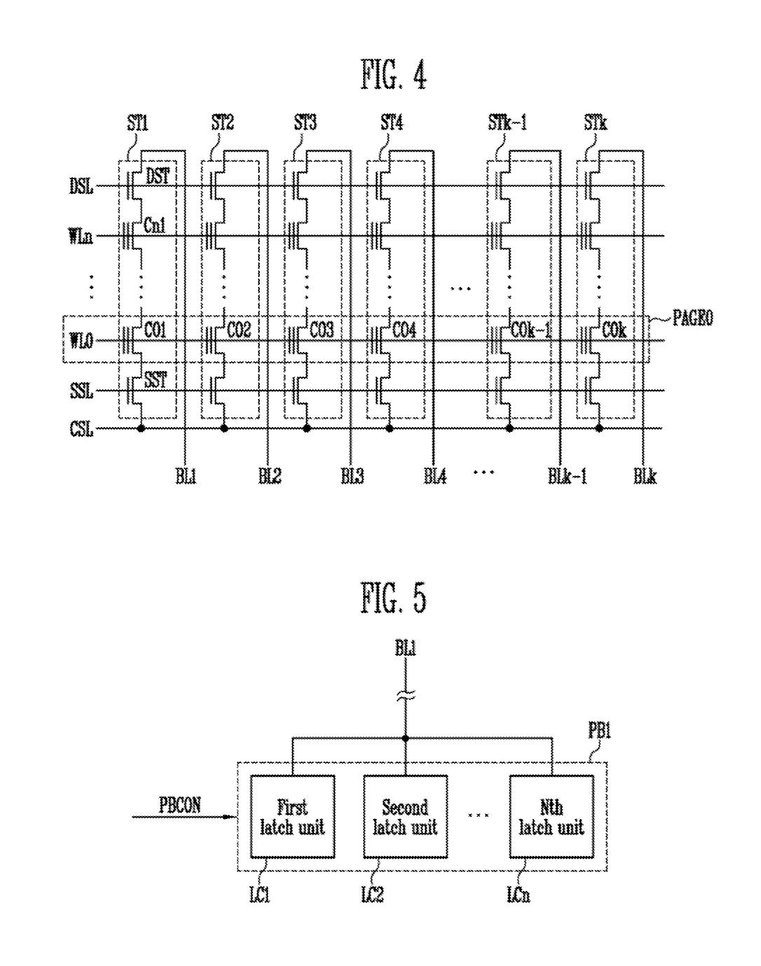

FIG. 3 is a block diagram for describing a semiconductor device illustrated in FIG. 1. FIG. 4 is a circuit diagram for describing a memory block illustrated in FIG. 3.

Referring to FIG. 3, the semiconductor device according to the exemplary embodiment of the present invention includes a memory array 210 including first to m^{th} memory blocks MB1 to MBm, and a peripheral circuit PERI for performing a program operation and a read operation on memory cells included in a selected page of the memory blocks MB1 to MBm, and particularly, performing a copy operation of copying data stored in the memory cells of first to n^{th} word lines of the first memory block among the memory blocks MB1 to MBm to first to n^{th} pages of the word line of the second memory block. The peripheral circuit PERI includes a control circuit 220, a voltage supply circuit 230, a page buffer group 240, a column decoder 250, and an input/output circuit 260.

Referring to FIG. 4, each memory block includes a plurality of strings ST1 to STk connected between bit lines BL1 to BLk and a common source line CSL. That is, the strings ST1 to STk are connected to the corresponding bit lines BL1 to BLk, respectively, and are commonly connected to the common source line CSL. Each string, i.e., a first string ST1, includes a source select transistor SST in which a source is connected to the common source line CSL, a plurality of memory cells C01 to Cn1, and a drain select transistor DST in which a drain is connected to the bit line BL1. The memory cells C01 to Cn1 are serially connected between the select transistors SST and DST. A gate of the source select transistor SST is connected to the source select line SSL, gates of the memory cells C01 to Cn1 are connected to word lines WL0 to WLn, respectively, and a gate of the drain select transistor DST is connected to a drain select line DSL.

The memory cells included in the memory block may be divided with a physical page or a logical page as a unit. For example, the memory cells C01 to C0k connected to one word lines (for example, WL0) configure one physical page PAGE0. The page serves as a basic unit of the program operation or the read operation.

The control circuit 220 outputs a voltage control signal VCON for generating operating voltages for the program operation and the read operation in response to a command CMD inputted through the input/output circuit 260 from the outside, and outputs a PB control signal PBCON for controlling page buffers PB1 to PBk included in the page buffer group 240 depending on the type of operation. Further, the control circuit 220 outputs a row address signal RADD and a column address signal CADD in response to an address signal ADD inputted from the outside through the input/output circuit 260.

The voltage supply unit 230 supplies the operating voltages necessary for the program operation and the read operation of the memory cells to local lines including a drain select line SLS, the word lines WL0 to WLn, and a source select line SSL of the selected memory block in response to the voltage control signal VON of the control logic 220. The voltage supply unit 230 includes a voltage generating circuit and a row decoder.

The voltage generating circuit outputs the operating voltages necessary for the program operation or the read operation of the memory cells to global lines in response to the voltage control signal VCON of the control circuit 220.

The row decoder connects the global lines and the local lines DSL, WL0 to WLn, and SSL in response to the row address signals RADD of the control circuit 220 so that the operating voltages outputted from the voltage generating circuit to the global lines may be transmitted to the local lines DSL, WL0 to WLn, and SSL of the selected memory block in the memory array 210.

The page buffer group 240 includes the plurality of page buffers PB1 to PBk connected with the memory array 210 through bit lines BL1 to BLk. The page buffers PB1 to PBk of the page buffer group 240 selectively precharge the bit lines BL1 to BLk based on data inputted to be stored in the memory cells C01 to C0k, or sense voltages of the bit lines BL1 to BLk in order to read the data from the memory cells in response to the PB control signal PBCON of the control circuit 220.

The column decoder 250 selects the page buffers PB1 to PBk included in the page buffer group 240 in response to the column address signal CADD outputted from the control circuit 220. That is, the column decoder 250 sequentially transmits the data to be stored in the memory cells to the page buffers PB1 to PBk in response to the column address signal CADD. Further, the column decoder 250 sequentially selects the page buffers PB1 to PBk in response to the column address signal CADD so that the data of the memory cells latched in the page buffers PB1 to PBk by the read operation is outputted to the outside.

In order to transmit the data inputted from the outside to the page buffer group 240 and store the data in the memory cells during the program operation, the input/output circuit 260 transmits the data to the column decoder 250 under control of the control circuit 220. When the column decoder 250 transmits the data transmitted from the input/output circuit 260 to the page buffers PB1 to PBk of the page buffer group 240, the page buffers PB1 to PBk store the inputted data in internal latch circuits. Further, the input/output circuit 260 outputs the data transmitted through the column decoder 250 from the page buffers PB1 to PBk of the page buffer group 240 to the outside.

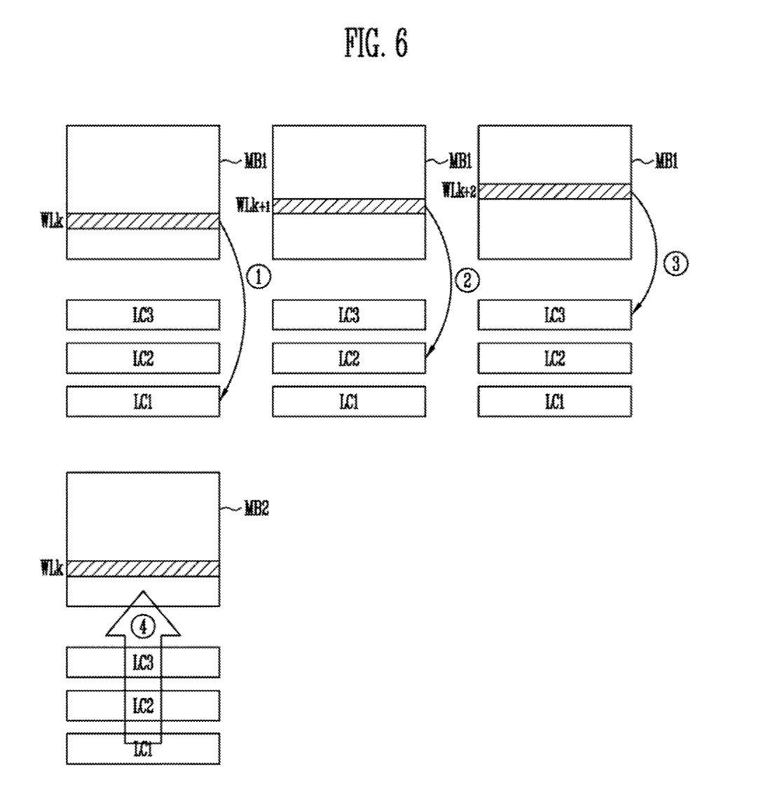

FIG. 5 is a circuit diagram illustrating the page buffer illustrated in FIG.

Referring to FIG. 5, the page buffer PB1 is operated in response to the PB control signal PBCON outputted from the control circuit 220 (see FIG. 3).

The page buffer PB1 includes a bit line connection circuit, a precharge circuit, and a plurality of latch units LC1 to LCn, but here, only the plurality of latch units LC1 to LCn will be described.

The latch units LC1 to LCn are connected to the bit line BL1 in parallel. The number of latch units LC1 to LCn may depend on a circuit design. The first latch unit LC1 temporarily stores the data read from the memory cell of the first word line of the first memory block by the read operation. The first latch unit LC1 may perform an operation of temporarily storing the data inputted from the outside and transmitting the data to one latch unit among the second to n^{th} latch units LC2 to LCn, or an operation of temporarily storing the data read from the memory cell by the read operation in order to output the read data to the outside. The second latch unit LC2 temporarily stores the data read from the memory cell of the second word line of the first memory block by the read operation. The n^{th} latch unit LCn temporarily stores the data read from the memory cell of the n^{th} word line of the first memory block by the read operation. The data of the memory cells of the first to n^{th} word lines of the first memory block, which is temporarily stored in the first to n^{th} latch units LC1 to LCn is programmed in the first to n^{th} pages of the word line of the second memory block. In order to perform the aforementioned operation, the latch units LC1 to LCn include a plurality of switching elements and latches

FIG. 6 is a block diagram for describing data transmission between the memory block illustrated in FIG. 4 and the page buffer illustrated in FIG. 5.

For simple description, a case in which the data stored in the memory cells of the first to third word lines WLk to WLK+2 of the first memory block MB1 is copied to the first to third pages of the word line WLk of the second memory block MB2 will be described as an example. Each page buffer includes the first to third latch units LC1 to LC3,

Referring to FIG. 6 the data stored in the first word line WLk of the first memory block MB1 is temporarily stored in the, first latch unit LC1 of the page buffer by the read operation.

The data stored in the second word line WLk+1 of the first memory block MB1 is temporarily stored in the second latch unit LC2 of the page buffer by the next read operation.

The data stored in the third word line WLk+2 of the first memory block MB1 is temporarily stored in the third latch unit LC3 of the page buffer by the next read operation (\textcircled{3}).

Last, the data temporarily stored in the first to third latch units LC1 to LC3 is programmed in the first to third pages of the word line WLk of the second memory block MB2 as lower bit data, intermediate bit data, and higher bit data. The lower bit data, the intermediate bit data, and the higher bit data may be simultaneously programmed.

The read data may be stored in the first to third latch units LC1 to LC3, and then outputted to the controller to perform an error correction operation (ECC), and the error-corrected data may be stored in the first to third latch units LC1 to LC3 and programmed in the memory cell.

The storage of the data of 3 bits in the memory cell of the second memory block MB2 has been described as an example, but the present invention may be applied to a case in which data of 2 bits or 4 bits is stored in the memory cell.

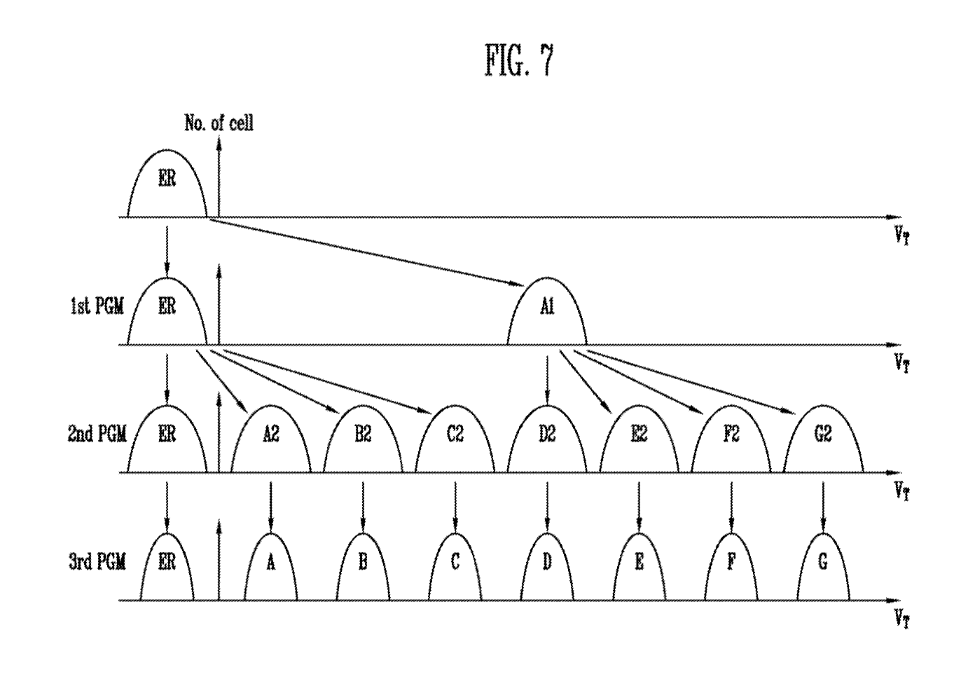

FIG. 7 is a diagram for describing a program sequence used in the semiconductor device illustrated in FIG. 3.

Referring to FIG. 7, in a first program step, threshold voltage distributions ER and A1 are formed based on data of the lowest bit among data of 3 bits.

Next, in a second program step, threshold voltage distributions ER and A2 to G2 are formed based on data of an intermediate bit and data of the highest bit among data of 3 bits.

Finally, in a third program step, threshold voltage distributions ER and A to G are detailed formed based on the data of the intermediate bit and the data of the highest bit among data of 3 bits. A width of each threshold voltage distribution is decreased by the third program, and a margin between the threshold voltage distributions is increased.

FIG. 8 is a flowchart illustrating an operating method of the data storing system according to the exemplary embodiment of the present invention.

Referring to FIG. 8, the operating method of the data storing system includes a first copy operation of copying data stored in memory cells of first to n^{th} word lines (n>1, and n is an integer) of a first memory block to first to n^{th} pages of a word line of a second memory block (S310). The first copy operation may be repeated. Data of 1 bit may be stored in the memory cell of the first memory block, and data of n bits may be stored in the memory cell of the second memory block.

Subsequently, sudden power off may occur (S320). When the data storing system is powered on after the sudden power off, a first page (first erase page) recognized to be in an erase state among the pages of the second memory block of which the program operation is stopped by the sudden power off is searched (S330).

Next, a map update is performed on pages, except for the specific number of pages copied before the first erase page among the pages on which the first copy operation is performed (S340). For example, on the assumption that the first erase page is a q^{th} page of the second memory block (q>n, and q is an integer), a map update may be performed on pages, except for nine pages copied before the q^{th} page. More specifically, a map update may be performed on 0^{th} to q−10^{th} pages, and a map update of q−9^{th} to q−1^{st} pages may be skipped.

According to an exemplary embodiment, each page may include a meta region storing a logical address corresponding to a physical address thereof. Logical addresses may be respectively read from meta regions of the 0^{th} to q−10^{th} pages, and a mapping table may be updated based on the read logical addresses. These logical addresses may be mapped to physical addresses of the 0^{th} to q−10^{th} pages.

Next, a second copy operation is performed from the first erase page (S350). Data may be sequentially written from the first erase page in a direction from a word line of the first memory block corresponding to the first erase page. For example, data stored in memory cells of q^{th} to p^{th} word lines of the first memory block may be stored in q^{th} to p^{th} pages of the second memory block, respectively, (p>g, and p is an integer)

Next, it is checked whether performance of the second copy operation is completed (S360), and when the performance of the second copy operation is not completed, the second copy operation is performed again.

When the second copy operation is completely performed to the last page of the second memory block, the map update is performed on the pages on which the second copy operation is performed (S370).

Accordingly, the operating method of the data storing system prevents the program operation from being performed on an unstable page by the sudden power off, thereby improving reliability of data.

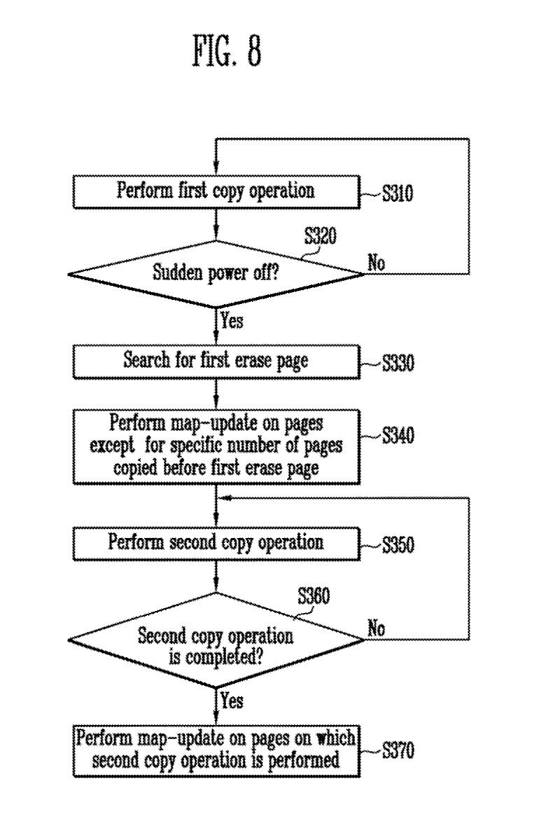

FIGS. 9 to 14 are flowcharts illustrating detailed steps of the operating method of the data storing system illustrated in FIG. 8.

Referring to FIG. 9, in the performing of the first copy operation (S310), data stored in the memory cells of the first to word lines of the first memory block is read (S312).

Then, the read data is programmed on the first to n pages of the word line of the second memory block (S314).

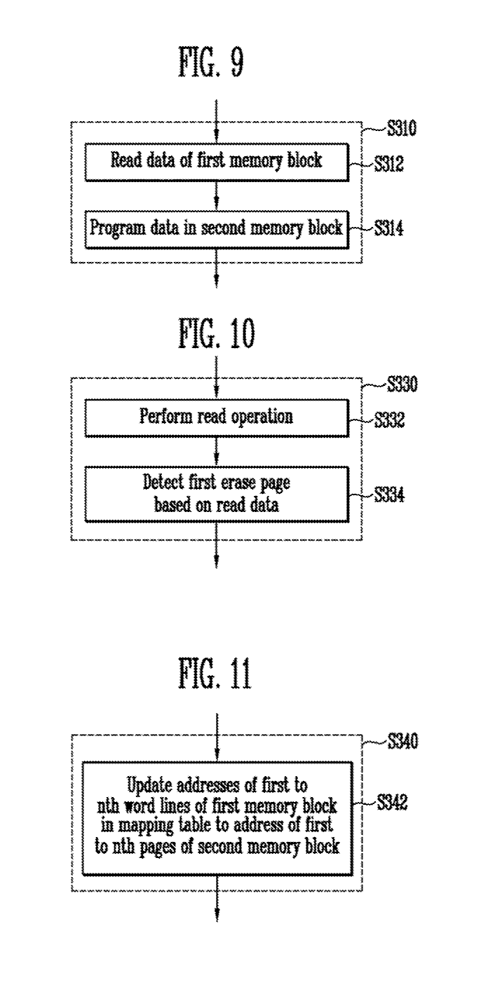

Referring to FIG. 10, in the searching for the first erase page (S330), a read operation (read scan operation) is first performed on the second memory block of which the program operation is stopped by the sudden power off (S332).

Next, the first erase page is detected based on the read data (S334).

Referring to FIG. 11, in the performance of the map update on pages, except for the specific number of pages copied before the first erase page among the pages on which the first copy operation is performed (S340) addresses of the first to n^{th} word lines of the first memory block on a mapping table are updated to address of the first to n^{th} pages of the second memory block. The first to n^{th} word lines of the first memory block refer to pages except for a specific number of pages copied before the first erase page.

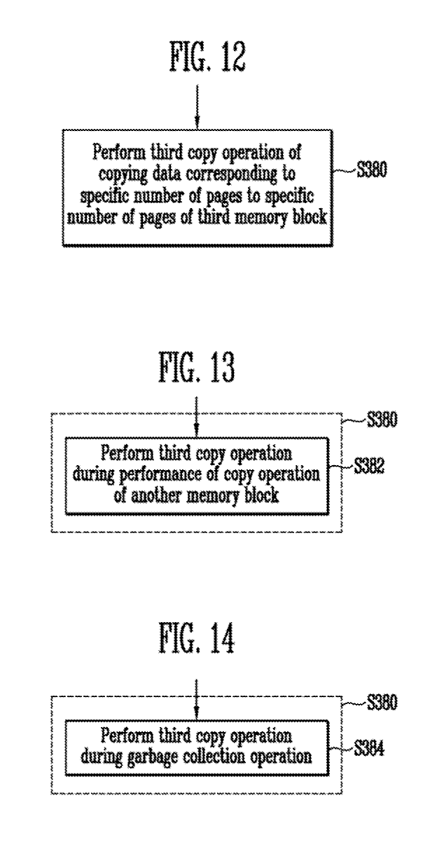

Referring to FIG. 12, the operating method of the data storing system may perform a third copy operation of copying the data stored in the memory cells of the word lines of the first memory block corresponding to the specific number of pages to the specific number pages of the third memory block (S380). That is, the copy operation of the specific number of pages copied before the first erase page is performed on the specific number of pages of the third memory block.

Referring to FIG. 13, the third copy operation may be performed during the performance of the copy operation of another memory block (S382).

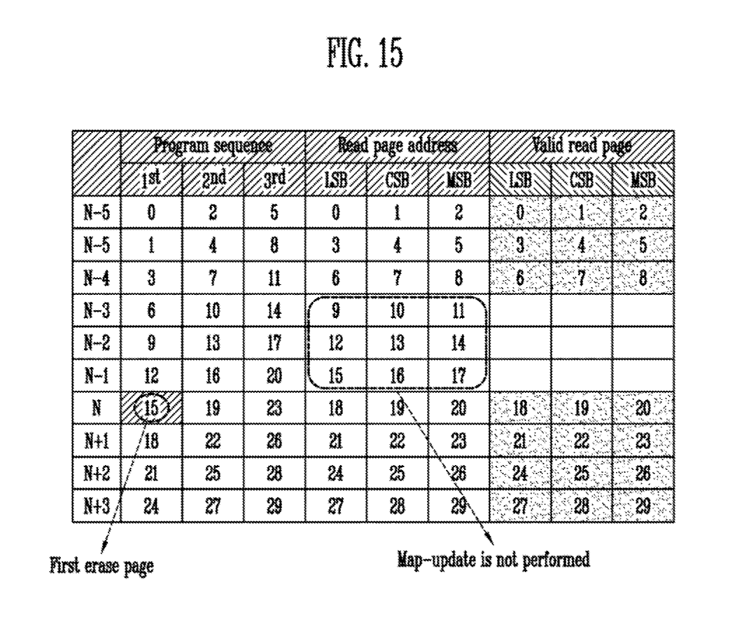

Referring to FIG. 14, the third copy operation may be performed during a garbage collection operation (S384).

FIG. 15 is a diagram for describing the operating method of the data storing system according to the exemplary embodiment of the present invention in a 3 bit multi level cell.

In FIG. 15, a case where the first to third program operations described with reference to FIG. 7 is performed, and the 3 bit data is stored in each memory cell of the second memory block is described as an example. That is, a LSB page, a CSB page, and an MSB page are present in one word line of the second memory block. This is for simple description, and even in a case where data of 2 bits, 4 bits or more is stored, the operating method of the data storing system according to the exemplary embodiment of the present invention may be applied.

A performance order of the program operation is controlled for each word line in order to decrease a movement of a threshold voltage distribution due to interference during the performance of the program operation on the memory cell. A number indicated in FIG. 15 represents a program operation performance order. For convenience, the numbers will be called zero page to a 29^{th} page.

Referring to FIG. 15, when power is turned on after the sudden power off, the first page (first erase page) recognized to be in the erase state is searched in the pages of the second memory block. The sudden power off is generated during the performance of the 14^{th} program operation, and the first erase page in which data is not stored in the memory cell is a page in which the 15^{th} program operation of the N^{th} word line is performed.

Since the sudden power off is generated during the performance of the 14^{th} program operation, a threshold voltage distribution in pages (a ninth page to a 17^{th} page) of N−3^{rd} to N−1^{st} word lines, on which first to third program operations are not normally performed, is unstable. In other words, it is difficult to ensure reliability of data stored in pages of the N−3^{rd} to N−1^{st} word lines. Accordingly, in order to improve reliability of the data, the copy operation of the unstable pages (the ninth page to the 17^{th} page) is skipped. The map update is not performed on the ninth page to the 17th page.

Accordingly, the operating method of the data storing system prevents the program operation from being performed on a page of which reliability may not be ensured due to the sudden power off, thereby improving reliability of data.

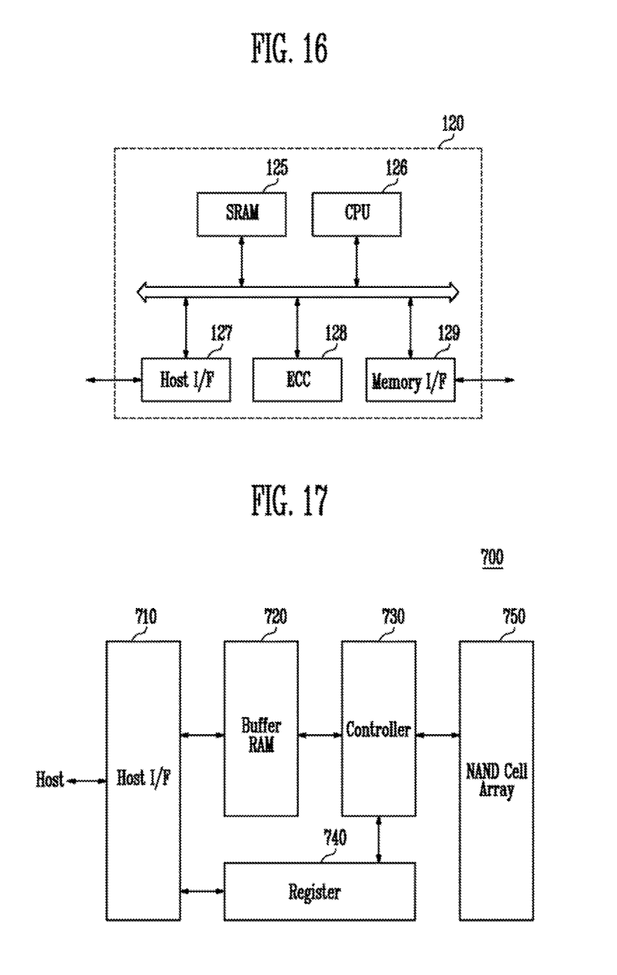

FIG. 16 is a block diagram for describing a detailed configuration of a controller illustrated in FIG. 1.

The data storing system 100 illustrated in FIG. 1 may be provided as a memory card or a Solid State Disk (SSD) by a combination of the semiconductor device 110 and the controller 120.

Referring to FIG. 16, the controller 120 includes an SRAM 121, a processing unit 126, a host interface 127, the error correction unit 128, and a memory interface 129. The SRAM 125 is used as an operating memory of the processing unit 126. The host interface 127 includes a data exchange protocol of a host connected with the data storing system 100. The error correction block 128 detects and corrects an error included in the data read from the semiconductor device 110. The memory interface 129 interfaces with the semiconductor device 110 of the present invention. The processing unit 126 performs a general control operation for the data exchange of the controller 120.

Although it is not illustrated in the drawing, it is apparent to those skilled in the art that the data storing system 100 according to the embodiment of the present invention may further include a ROM storing code data for interfacing with the host. The semiconductor device 110 may also be provided in a form of a multi-chip package including a plurality of flash memory chips. The data storing system 100 of the present invention may be provided as a storage medium having a low error generation risk and high reliability. Especially, the semiconductor device of the present invention may be included in a memory system, such as an SSD (Solid State Drive) actively being studied. In this case, the controller 120 may communicate with an external device (for example, the host) through one of various interface protocols, such as USB, MMC, PCI-E, SATA, PATA, SCSI, ESDI, and IDE.

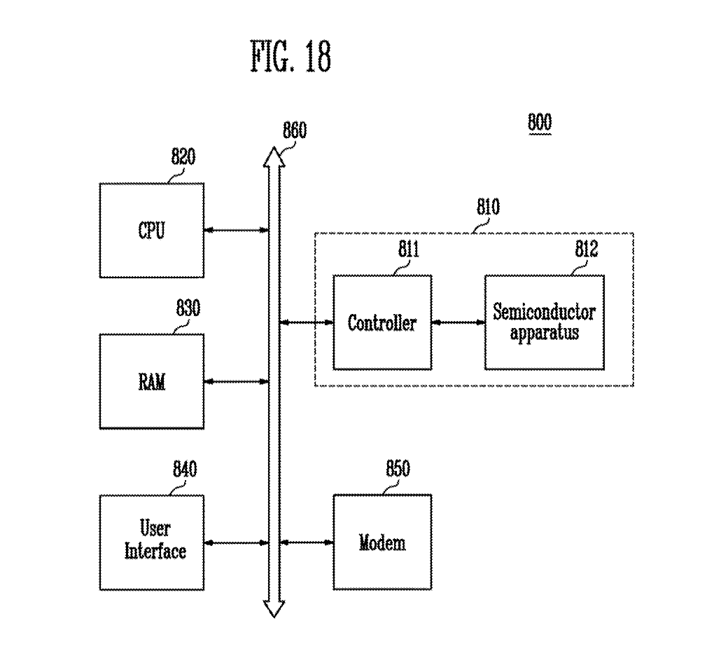

FIG. 17 is a block diagram schematically illustrating a fusion memory device or a fusion memory system performing program operations according to aforementioned various embodiments. For example, the technical features of the present invention may be applied to an OneNAND flash memory device 700 as a fusion memory device.

The OneNAND flash memory device 700 includes a host interface 710 for exchanging various information with a device using different protocols, a buffer RAM 720 including a code for driving the memory device, or temporarily storing data, a controller 730 configured to control a read, a program, and all states in response to a control signal and a command provided from the outside, a register 740 storing a command, an address, and data, such as configuration, defining a system operating environment within the memory device, and a NAND flash cell array 750 formed of the operating circuit including a nonvolatile memory cell and a page buffer. The OneNAND flash memory device programs the data in response to a write request from the host by the aforementioned method.

FIG. 18 schematically illustrates a computing system including a semiconductor device 812 according to the embodiment of the present invention.

The computing system 800 according to the embodiment of the present invention includes a microprocessor 820 electrically connected to a system bus 860, a RAM 830, a user interface 840, a modem 850, such as a baseband chipset, and a data storing system 810. In a case where the computing system 800 according to the embodiment of the present invention is a mobile device, a battery (not shown) for supplying an operating voltage of the computing system 800 may be further provided. Although it is not illustrated in the drawing, it is apparent to those skilled in the art that the computing system 800 according to the embodiment of the present invention may further include an application chipset, Camera Image Processor (CIS), a mobile DRAM, and the like. The data storing system 810 may configure, for example, an SSD using a nonvolatile memory for storing data. Otherwise, the data storing system 810 may be provided as a fusion flash memory (for example, an OneNAND flash memory).

The above-mentioned exemplary embodiments of the present invention are not embodied only by an apparatus and method. Alternatively, the above-mentioned exemplary embodiments may be embodied by a program perforating functions, which correspond to the configuration of the exemplary embodiments of the present invention, or a recording medium on which the program is recorded. These embodiments can be easily devised from the description of the above-mentioned exemplary embodiments by those skilled in the art to which the present invention pertains.

As described above, the embodiment has been disclosed in the drawings and the specification. The specific terms used herein are for purposes of illustration, and do not limit the scope of the present invention defined in the claims. Accordingly, those skilled in the art will appreciate that various modifications and another equivalent example may be made without departing from the scope and spirit of the present disclosure. Therefore, the sole technical protection scope of the present invention will be defined by the technical spirit of the accompanying claims.

What is claimed is:

1. A method of operating a data storing system, comprising:
performing a first copy operation of copying data stored in memory cells of first to n^{th} word lines of a first memory block to first to n^{th} pages of a word line of a second memory block, wherein the n is an integer greater than 1;
if a power is turned off, searching for a first erase page, which is recognized to be in an erase state, among the pages of the second memory block when the power comes back on;
performing a first map-update on copied pages of the second memory block except for a set number of pages copied right before the first erase page; and
performing a second copy operation from the first erase page.

2. The method of claim 1, further comprising;
performing a second map-update on pages on which the second copy operation is performed, after the performing of the second copy operation.

3. The method of claim 1, further comprising:
performing a third copy operation of copying data stored in memory cells of word lines of the first memory block corresponding to the set number of pages to a set number of pages of a third memory block.

4. The method of claim 3, wherein the third copy operation is performed during a copy operation of another memory block.

5. The method of claim 3, wherein the third copy operation is performed during a garbage collection operation.

6. The method of claim 1, wherein in the performing of the first map-update addresses of the first to n^{th} word lines of the first memory block are updated to corresponding addresses of the first to n^{th} pages of the second memory block in a mapping table.

7. The method of claim 1, wherein data of 1 bit is stored in a memory cell of the first memory block, and data of n bits is stored in a memory cell of the second memory block.

8. The method of claim 1, wherein the searching for the first erase page, which is recognized to be in the erase state, among the pages of the second memory block includes:
performing a read operation on the pages of the second memory block; and
detecting a page, which is first recognized to be in the erase state, among the pages of the second memory block as the first erase page based on read data.

9. The method of claim 1, wherein the performing of the first copy operation includes:
reading the data stored in the memory cells of the first to n^{th} word lines of the first memory block; and
programming read data in the first to n^{th} pages of he word line of the second memory block.

10. A data storing system, comprising:
a semiconductor device suitable for performing a first copy operation of copying data stored in memory cells of first to n^{th} word lines of a first memory block to first to n^{th} pages of a word line of a second memory block in response to a command and an address, wherein the n is an integer greater than 1; and
a controller suitable for generating the command and the address and performing a map-update on copied pages of the second memory block,
wherein when a power is turned on after a sudden power off, the controller detects a first erase page, which is recognized to be in an erase state, among the pages of the second memory block, and performs the map-update on the coped pages except for a set number of pages copied right before the first erase page.

11. The data storing system of claim 10, wherein the semiconductor device performs a second copy operation from the first erase page of the second memory block in response to the command and the address when the power is turned on after the sudden power off.

12. The data storing system of claim 11, wherein the controller comprises:
a sudden power off detection unit suitable for generating detection signal when the power is turned on after the sudden power off;
a command and address generating unit suitable for generating the command and the address in response to the detection signal;
a page detection unit suitable for detecting the first erase page, by performing a read operation on the pages of the second memory block; and
an address mapping unit suitable for performing the map-update on the copied pages of the second memory block based on a detecting result of the page detection unit.

13. The data storing system of claim 11, wherein the semiconductor device performs a third copy operation of copying data stored in memory cells of word lines of the first memory block corresponding to the set number of pages to a set number of pages of a third memory block in response to the command and the address.

14. The data storing system of claim 13, wherein the third copy operation is performed during a copy operation of another memory block.

15. The data storing system of claim 13, wherein the third copy operation is performed during a garbage collection operation.

16. The data storing system of claim 12, wherein the address mapping unit includes a mapping table, and updates addresses of the first to n^{th} word lines of the first memory block to corresponding addresses of the first to n^{th} pages of the second memory block in the mapping table.

17. The data storing system of claim 10, wherein the semiconductor device stores data of 1 bit in a memory cell of the first memory block, and stores data of n bits in a memory cell of the second memory block.

18. The data storing system of claim 10, wherein the semiconductor device reads the data stored in the memory cells of the first to n^{th} word lines of the first memory block, and then programs read data in the first to n^{th} pages of the word line of the second memory block during the performance of the first copy operation.
